(19) United States
(12) Patent Application Publication
(10) Pub. No.: US 2008/0152994 A1
(43) Pub. Date: Jun. 26, 2008

(54) Battery pack

(76) Inventors: Sadao Yamagami, Sumoto-shi (JP); Masatsugu Naka, Sumoto-shi (JP); Ryosuke Kubo, Sumoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/987,763

(22) Filed: Dec. 4, 2007

(30) Foreign Application Priority Data
Dec. 4, 2006 (JP) 2006-327462

(51) Int. Cl. H01M 2/00

(52) U.S. Cl. 429/100

(57) ABSTRACT

In a battery pack, a battery core pack having a connector is inserted into a resin molded portion which is formed of a plastic material. The battery core pack includes a rechargeable unit cell, a circuit board electrically connected to the unit cell, and a connector fixed to the circuit board. The connector incorporates a contact point in a connector casing which is formed of an insulation material, and the connector casing is inserted into the resin molded portion so as to partially appear to a surface of the resin molded portion. Further, the battery pack is provided with a sealing groove at a boundary between the connector casing and the resin molded portion, along a peripheral edge of an exposed portion of the connector, appearing outside the resin molded portion.

### BACKGROUND OF THE INVENTION

1. Field of the Invention

The present invention relates to a battery pack where a battery core pack having a connector is insert-molded into a resin molded portion and, in particular, a battery pack where the battery core pack is temporally tacked in a metal mold which molds the resin molded portion, the battery core pack is inserted into the resin molded portion in a process of forming the resin molded portion, and thus the resin molded portion is integrally structured with the battery core pack.

2. Description of the Related Art

A conventional battery pack is assembled by containing a core pack in a plastic outer casing, with components required of a battery being interconnected in the core pack. A manufacture of the battery pack in such a structure is labor and time consuming, because the core pack is assembled by being fixedly inserted in place within an outer casing. On the other hand, there has been developed a battery pack which does not have an outer casing. In production of such battery pack, a battery core pack is inserted when forming a resin molded portion equivalent to the outer casing. In manufacturing the battery pack in this structure, necessary components are interconnected to a unit cell to make up a battery core pack, the core pack is temporally tacked in a cavity of a metal mold which forms the resin molded portion, a molten plastic material is injected into the cavity, and the battery core pack is insert-molded in the injected plastic material. Since such battery pack allows for fixation to the battery when forming the resin molded portion, it becomes possible to manufacture a larger number of battery packs efficiently without calling for an outer casing. While allowing a part of outer casing of the battery pack to be formed, the resin molded portion also serves to integrally fix various components being connected to a unit cell. Therefore, such method carries the advantage that a mass production is made possible with a higher efficiency and at a lower cost, because the core pack can be fixed when the resin molded portion is formed.

In the battery pack in such structure, a connector incorporating an output terminal is insert-molded in the resin molded portion, which enables the output terminal to be placed in a predetermined position. See Japanese Patent Laid-Open Publication Nos. 2002-260615 and 2003-208880.

### SUMMARY OF THE INVENTION

The battery packs as described in the above documents are manufactured in the processes that a connector having an output terminal is fixed to a circuit board, that the circuit board is connected to a battery to make up a battery core pack, and that the core pack is inserted into a resin molded portion being formed of a plastic material. It is required of the battery pack to allow the output terminal of the connector to appear outside the resin molded portion. Therefore, a part of the connector serves as an exposed portion, which appears outside of resin molded portion, and the output terminal is disposed to the exposed portion. In the battery pack in this structure, it sometimes happens that the output terminal of the connector is covered or insulated with the plastic material in the process of forming the resin molded portion. This state happens because when the battery core pack is temporally tacked to a metal mold to form the resin molded portion, a gap is prone to be produced between the metal mold and the connector, and the plastic material leaks through the gap to cover the exposed portion. In particular, in order to form the resin molded portion in an accurate shape, a pressurized molten resin is injected into a cavity. Because of this process, any slight gap existing between the connector and the metal mold may cause a leakage of the plastic material which is injected under a pressure. Since the gap between the connector and the metal mold is caused by a dimensional error in the battery core pack, it is necessary to assemble the battery core pack in a very high precision to eliminate such gap. For realization of a precision assembly, the connector itself has to be produced in a high precision, the connector has to be fixed, in an accurate posture, to an accurate position in the circuit board, and further the circuit board has to be connected to the battery without their relative misalignment, in a high precision level, to make up the core pack. In view of such requirements, an assembly of the battery core pack is made more difficult, and further because a high dimensional accuracy is required of the used components, it becomes difficult to achieve a mass production of the core pack with efficiency and ease, disadvantageously resulting in a higher cost of production.

Further, in the battery pack, which has the connector fixed to the circuit board and inserted into the resin molded portion, the plastic material for forming the resin molded portion is prone to leak through the gap existing between the connector and the circuit board. Such leaked plastic material will cause a poor contact for the output terminal incorporated in the connector. This is because the leaked plastic material is to cover a surface of the output terminal or to prevent the output terminal from an elastic deformation. Such disadvantage can be eliminated when a sealant is filled in between the connector and the circuit board. However, it is highly time-consuming to unfailingly fill the sealant such that no gap will be present between an entire circumference of the connector and the circuit board, which can be an additional factor for a higher cost of the battery core pack production, being accompanied by a lower efficiency in production.

The present invention has been made to remedy the above-mentioned shortcomings. It is the primary object to provide a battery pack where a battery core pack having a connector is insert-molded into a resin molded portion, the connector is firmly fixed to the resin molded portion, as well as an output terminal of the connector is made securely connectable to a terminal of an electric appliance.

In regard to the battery pack in accordance with a first aspect of the present invention, a battery core pack 10 having a connector 9 is insert-molded into a resin molded portion 1 which is formed of a plastic material. The battery core pack 10 includes a rechargeable unit cell 2, a circuit board 3 electrically connected to the unit cell 2, and the connector 9 fixed to the circuit board 3. The connector 9 incorporates a contact point 22 in a connector casing 20 which is formed of an insulation material, and the connector casing 20 is insert-molded into the resin molded portion 1 so as to partially appear to a surface of the resin molded portion 1. Further, the battery pack is provided with a sealing groove 25 at a boundary between the connector casing 20 and the resin molded portion 1, along a peripheral edge of an exposed portion 9A of the connector 9, with a part of the connector casing 20 appearing outside the resin molded portion 1.

The above-described battery pack carries the advantage that while the battery core pack having the connector is insert-molded into the resin molded portion to firmly fix the connector to the resin molded portion, the connector is insert-molded into the resin molded portion in an ideal state, so that the output terminal of the connector is electrically connectable to the terminal of the electric appliance in a secure manner. In particular, the battery pack according to the first aspect of the invention is provided with the sealing groove along the boundary between the exposed portion of the connector and the resin molded portion, so that the sealing groove can unfailingly prevent the plastic material, for forming the resin molded portion, from leaking toward the exposed portion. This becomes possible because the sealing groove is formed by a groove-forming ridge, provided in a metal mold, which ridge is linearly pressed on to a surface of the connector, and thus the resin molded portion can be formed in a state where the groove-forming ridge reduces or eliminates a gap with respect to the surface of the connector. The groove-forming ridge, which is linearly put into tight contact with the surface of the connector, is to be locally in tight contact with the surface of the connector, so that when the ridge is pressed on to the connector with a predetermined level of pressure, a gap can be eliminated with respect to the connector. Owing to this structure, a plastic material cannot get through the gap between the connector and the metal mold to cover the exposed portion, the exposed portion can be accurately formed, the output terminal does not fail to appear externally, and a poor contact of the output terminal with the electric appliance can be avoided.

In the battery pack in accordance with a second aspect of the present invention, a battery core pack 10 having a connector 9 is insert-molded into a resin molded portion 1 which is formed of a plastic material, and the connector 9 is structured integrally with the resin molded portion 1. The battery core pack 10 includes a rechargeable unit cell 2, a circuit board 3 electrically connected to the unit cell 2, and the connector 9 fixed to the circuit board 3. The connector 9 is so structured as to incorporate a contact point 22 in a connector casing 20 which is formed of an insulation material. The connector casing 20 is provided with a capillarity groove 27 to allow a sealant 26 to be filled at a boundary with respect to the circuit board 3 by a capillarity effect. In the battery pack, the capillarity groove 27 is filled with the sealant 26 to seal a gap existing between the connector casing 20 and the circuit board 3, and the battery core pack 10 is insert-molded into the resin molded portion 1, so that the connector 9 is insert-molded into the resin molded portion 1.

The above-described battery pack carries the advantage that since the capillarity groove is provided, with respect to the circuit board, to be filled with the sealant by the capillarity effect so that the sealant may be diffused and filled in the capillarity groove by the capillarity effect, there does not exist a gap between the connector and the circuit board, and thus the plastic material can be prevented from penetrating into the connector through the gap. Because of this structure, the plastic material for forming the resin molded portion does not enter the connector, so that a poor contact of the output terminal of the connector can be avoided.

According to a third aspect of the present invention, the battery pack has a structure of battery packs based on both of the first and second aspects of the invention, where a battery core pack 10 having a connector 9 is insert-molded into a resin molded portion 1 formed of a plastic material. The battery core pack 10 includes a rechargeable unit cell 2, a circuit board 3 electrically connected to the unit cell 2, and the connector 9 fixed to the circuit board 3. The connector 9 is provided with a capillarity groove 27 to allow a sealant 26 to be filled at a boundary with respect to the circuit board 3 by a capillarity effect. In the battery pack, the battery core pack 10 is inserted into and formed in the resin molded portion 1 such that the capillarity groove 27 is filled with the sealant 26 to seal a gap existing between the connector 9 and circuit board 3. Further, the connector 9 incorporates a contact point 22 in the connector casing 20 formed of an insulation material, and the connector casing 20 is insert-molded into the resin molded portion 1 so as to partially appear to a surface of the resin molded portion 1. Further, the battery pack is provided with a sealing groove 25 at a boundary between the connector casing 20 and the resin molded portion 1, along a peripheral edge of an exposed portion 9A of the connector 9, the exposed portion 9A appearing outside the resin molded portion 1.

The above-described battery pack carries the advantage that the sealing groove, provided between the exposed portion and the resin molded portion, prevents the exposed portion of the connector from being covered by the plastic material for forming the resin molded portion, and further both the capillarity groove provided to the connector and the sealant filled in the groove prevent the plastic material from penetrating inside the connector. Because of this structure, in the battery pack, the exposed portion is not covered with the plastic material and also the plastic material is not introduced into the connector, so that a poor contact of the output terminal of the connector can be limited to an extremely low level.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view of the battery pack in accordance with an embodiment of the present invention;

FIG. 2 is an exploded perspective view of the battery pack shown in FIG. 1;

FIG. 3 is an enlarged perspective view showing the structure of interconnection between the unit cell in the battery pack and the insulation cover as illustrated in FIG. 2;

FIG. 4 is a cross-sectional view showing how the resin molded portion is formed in the portion of the safety valve of the battery pack in accordance with an embodiment of the invention;

FIG. 5 is a perspective view showing the structure of interconnection between the circuit board and the connector casing;

FIG. 6 is a cross-sectional perspective view of the circuit board and the connector casing shown in FIG. 5;

FIG. 7 is a cross-sectional perspective view showing the connector portion of the battery pack as illustrated in FIG. 1;

FIG. 8 is a perspective view showing the connector portion of the battery pack as illustrated in FIG. 1;

FIG. 9 is a cross-sectional view showing how the resin molded portion of the connector portion is formed in the battery pack in accordance with an embodiment of the invention;

FIG. 10 is a cross-sectional view showing how the resin molded portion of the connector portion is formed in the battery pack in accordance with an alternative embodiment of the invention; and

FIG. 11 is a horizontal cross-sectional view showing the boundary between the circuit board and the connector casing as illustrated in FIG. 5.

### DETAILED DESCRIPTION OF THE PREFERRED EMBODIMENT(S)

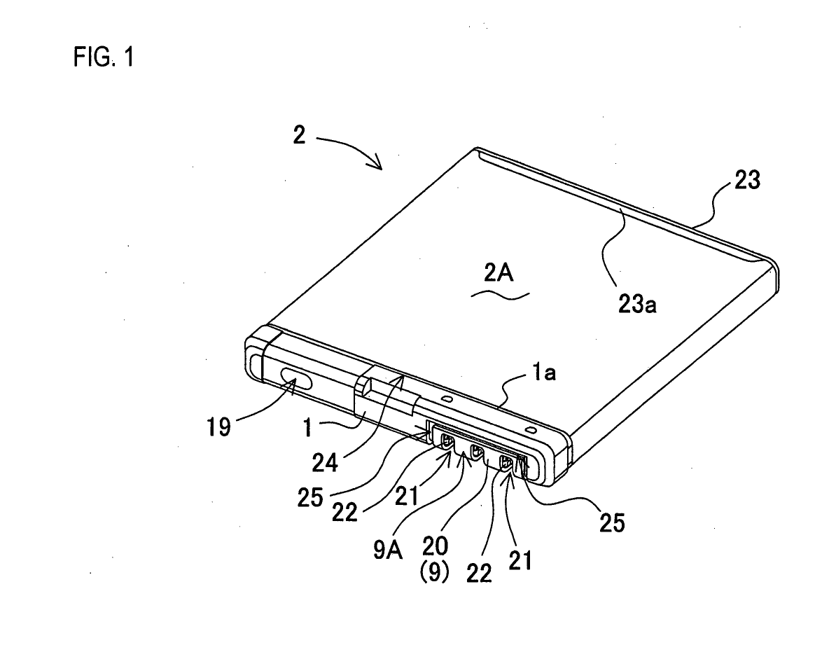

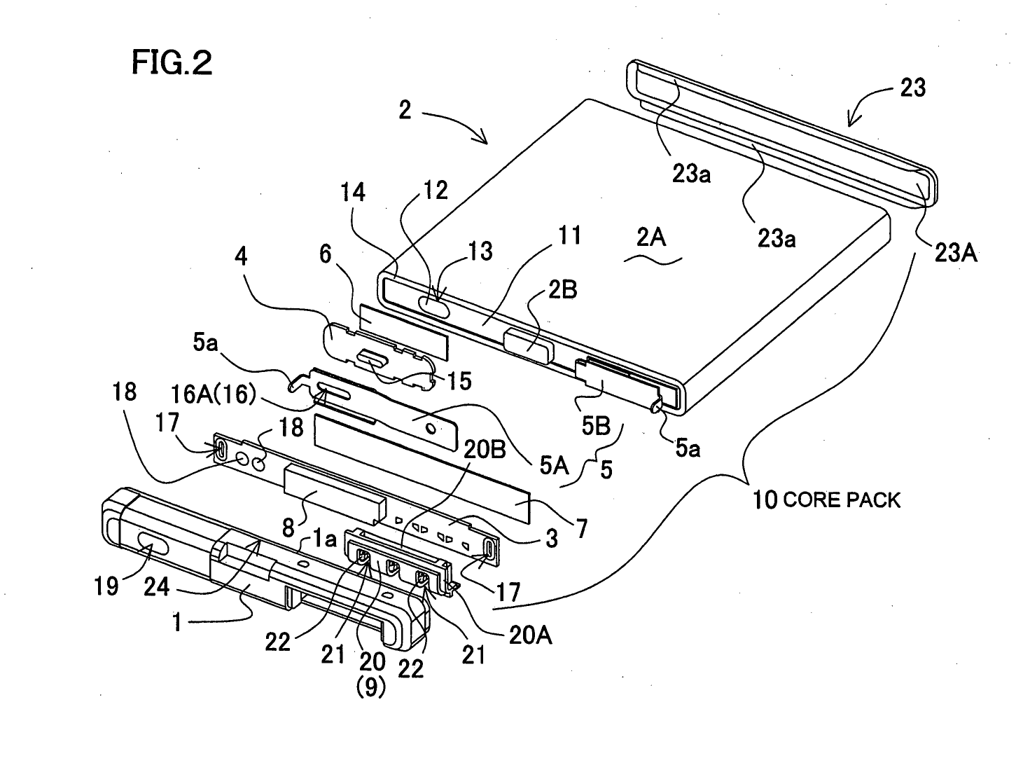

The battery pack shown in FIG. 1 through FIG. 4 is produced by insert-molding a battery core pack 10 into a resin molded portion 1. FIG. 2 is an exploded perspective view of the battery pack. In order to facilitate a better understanding of each individual component, this Figure shows a separated state of a resin molded portion 1, a circuit board 3, a connector 9, a lead plate 5, an insulation cover 4, and a unit cell 2. In the process of forming the resin molded portion 1 for the battery pack, the circuit board 3 to which the connector 9 is fixed, the lead plate 5, and the insulation cover 4 are inserted into the resin molded portion 1. Therefore, when the resin molded portion 1 has been formed of a plastic material, the battery core pack 10 comes to be integrally structured with the resin molded portion 1. In the illustrated battery pack, a part of the battery core pack 10 is insert-molded into the resin molded portion 1, but the present invention does not limit the part of insert-molding the core pack into the resin molded portion specifically to the insulation cover, the lead plate and the circuit board. This is because, although not shown, the entirety of the battery core pack can also be insert-molded into the resin molded portion. A battery pack can be made compact in its entirety when a part of the battery core pack 10 is insert-molded into the resin molded portion 1. In addition, a battery pack can be increased in its entire strength when the entire battery core pack is inserted into the resin molded portion.

In the illustrated battery pack, the battery core pack 10 is made up by using the unit cell 2 in which a sealing plate 11, as one end surface of battery provided with a protruded electrode 2B, is provided with an outlet port 13 as a safety valve 12, so that the resin molded portion 1 is formed so as to cover the end surface of battery serving as the sealing plate 11. In the inventive battery pack, however, it is also possible to provide the outlet port as the safety valve to an end surface of the battery opposite to the sealing plate so that the resin molded portion may be fixed to the opposite side. Further, although not shown, it is also possible to provide the outlet ports as the safety valve to both sides of the unit cell so that the resin molded portion is provided to cover an aperture of this safety valve.

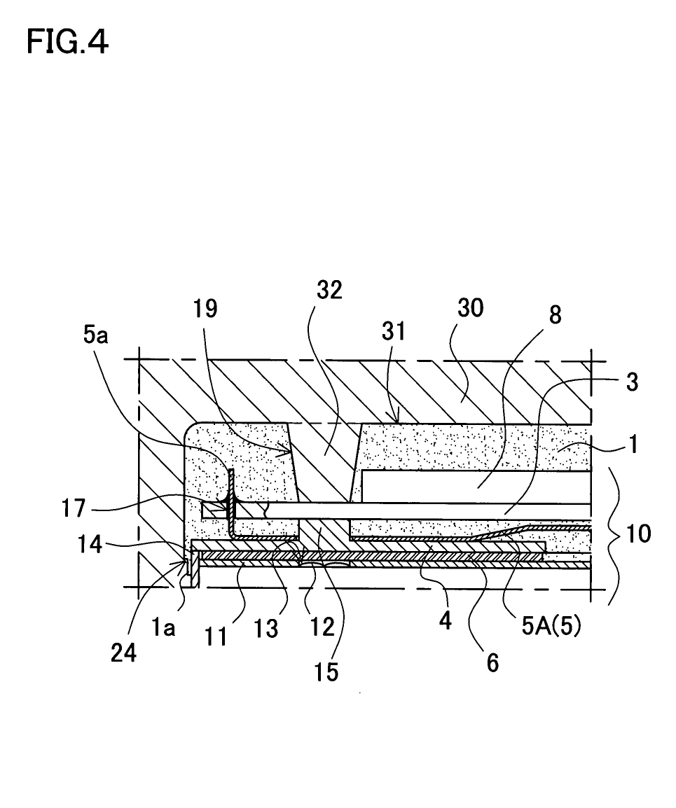

As shown in the cross-sectional view in FIG. 4, the battery pack is manufactured by temporally tacking the battery core pack 10 in a cavity 31 of the metal mold 30, by injecting a molten plastic material into the cavity 31, and by insert-molding a part of the core pack 10 into the resin molded portion 1.

The battery core pack 10 is composed of the unit cell 2; the insulation cover 4, disposed at a position facing the outlet port 13 as the safety valve 12 provided to the unit cell 2, for insulating the lead plate 5 from the unit cell 2; the lead plate 5 layered on the insulation cover 4, and the circuit board 3 connected to and layered on the lead plate 5.

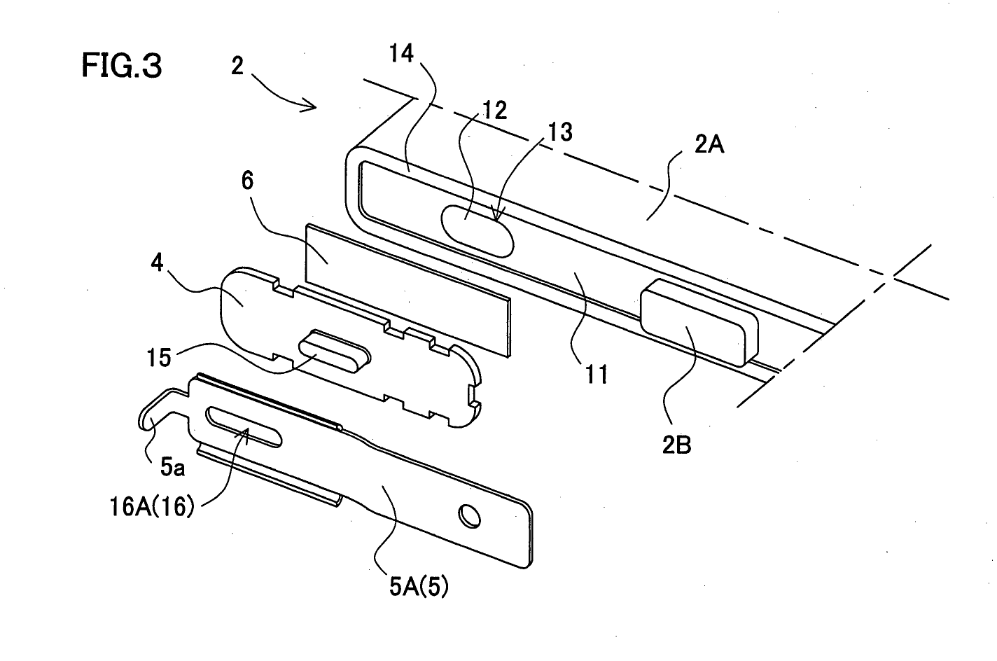

The unit cell 2 is a lithium-ion battery. However, instead of the lithium-ion battery, the unit cell may be any rechargeable type of secondary battery including a nickel-hydrogen battery and nickel-cadmium battery. The illustrated battery pack uses a thin-type battery as the unit cell 2. The thin-type battery is shaped such that the outer package 2A is curved at both sides and chamfered at four corners. When a lithium-ion battery is used as the thin-type battery, a chargeable capacity can be increased with respect to the total capacity of the battery pack. The unit cell 2, as shown in FIG. 2 and FIG. 3, is provided with the safety valve 11 at the sealing plate 11 which is provided with the protruded electrode 2B. The unit cell 2 is provided with the protruded electrode 2B in the center portion of the sealing plate 11 and also with the safety valve 12 at one end. The safety valve 12 is designed to open when an interior pressure level in the battery 2 exceeds a predetermined pressure level. In the illustrated safety valve 12, the outlet port 13 is closed by a thin film valve which is broken when the interior pressure level reaches the predetermined pressure level. Although the safety valve 12 being the thin film valve can be simplified in its structure, the insulation cover 4 might be deformed or broken by a forming pressure of the resin molded portion 1. The illustrated battery pack has the insulation cover 4 disposed to cover the outlet port 13 of the safety valve 12, so that the safety valve 12 is prevented from being broken by a plastic forming pressure when forming the resin molded portion 1. It should be noted that the battery pack can also use a safety valve in any of such a structure as may open when a predetermined pressure level is reached, for example, a safety valve in which an elastic material presses a valve material elastically. Even a safety valve in such structure may not perform a normal function due to the valve material being opened when the plastic material leaks through the outlet port. In the case of a safety valve which operates normally, when the interior pressure level in the battery exceeds the predetermined pressure level, the valve opens and exhausts an interior gas and others to stop an increase in the interior pressure level.

The insulation cover 4 is stacked on the sealing plate 11 serving as an opening surface of the safety valve 12 in such a manner as faces the outlet port 13 of the safety valve 12 in the unit cell 2. The illustrated insulation cover 4 is contoured to run along the peripheral edge of the end surface of the unit cell 2, and is formed to such a size as may be disposed at one end of the battery end surfaces. It should be noted that the insulation cover may also be contoured to be fitted inside a ridge 14 provided along the peripheral edge of the sealing plate 11 and can be formed to such a contour as may be disposed inside the ridge 11 and the protruded electrode 2B. The insulation cover can be fitted inside the ridge 14 to be disposed in an accurate position of the sealing plate 11.

The insulation cover 4 closes the outlet port 13 of the safety valve 12 when the resin molded portion 1 is formed, and is situated between the lead plate 5 and the sealing plate 11 to insulate the lead plate 5 from the sealing plate 11. The insulation cover 4 is a plate formed of such a rigid insulation material as may not be deformed by the forming pressure of the plastic material injected into the cavity for temporally tacking the battery core pack 10, for example, a rigid plastic plate such as a glass fiber reinforced epoxy plate and phenol plate. The insulation cover, however, is not limited to a rigid plastic material, but may also be such a rigid plate as may be composed of an insulation material to cover the surface or the entirety, for example, a metallic plate with its surface being coated by an insulation layer, a plate with an inorganic material being formed into a plate, or the like.

The insulation cover 4 is provided, on its surface, with a protrusion 15 which is pressed out by using a press pin 32 in the metal mold 30 for forming the resin molded portion 1, as shown in FIG. 4. The protrusion 15 is pressed by the press pin 32 protruding toward the interior face of the cavity 31 and being provided to the cavity 31 of the metal mold 30. The protrusion 15 is pressed by the press pin 32 in the metal mold 30 which is closed when the resin molded portion 1 is formed, and the insulation cover 4 comes into tight contact with the surface of the unit cell 2. The illustrated battery pack has the circuit board 3 layered on a top end surface of the protrusion 15 of the insulation cover 4. In the battery pack in this structure, when a molten plastic material is injected into the cavity 31, the protrusion 15 of the insulation cover 4 is pressed, via the circuit board 3, by the press pin 32 in the metal mold 30, so that the insulation cover 4 is pressed in a direction of being in tight contact with the surface of the unit cell 2. The illustrated circuit board 3 is provided, on its surface, with a test point 18 which is exposed outside the resin molded portion 1, and the protrusion 15 of the insulation cover 4 is pressed at the back surface of the circuit board 3. In the battery pack in this structure, the circuit board 3 is pressed by the press pin 32 in the metal mold 30, and further the protrusion 15 of the insulation cover 4 is pressed at the back surface of the circuit board 3 to bring the insulation cover 4 into tight contact with the surface of the unit cell 2. In particular, in this battery pack, both of the circuit board 3 and the insulation cover 4 can be positioned in place in the metal mold 30 where the resin molded portion 1 is provided with a test window 19 which allows the test point 18 provided to the circuit board 3 to appear externally.

The insulation cover 4 shown in FIG. 2 through 4 is provided with the protrusion 15 at a position facing the outlet port 13 of the safety valve 12. Yet, the protrusion of the insulation cover may be provided at a position which is shifted laterally from the outlet port of the safety valve, namely, at a position for pressing the surface of the sealing plate.

The protrusion 15 is in an elongated shape extending in the longitudinal direction of the sealing plate 11. The protrusion 15 serves to press the insulation cover 4, over a given length, against the sealing plate 11 of the unit cell 2, and allows the insulation cover 4 to be in tight contact with the sealing plate 11 over a long area. The elongated protrusion 15 is also convenient for being inserted into a slit 16 provided to the lead plate 5. This is because a width of an open hole 16 provided to the lead plate 5 can be made into a narrow slit 16A. The open hole 15 for inserting the protrusion 15 provided to the lead plate 5 increases an electric resistance of the lead plate 5, and also causes strength to be decreased. When the open hole 16 can be made to the narrow slit 16, an increase in the electric resistance of the lead plate 5 can be made smaller and a decrease in the strength of the lead plate 5 can be made smaller, so that the lead plate 5 can be connected without a misalignment with the insulation cover 4.

The insulation cover 4 is adhesively fixed to the sealing plate 11 of the battery 2 via double coated adhesive tape 6 which has adhesive layers on both faces. The double coated adhesive tape 6 is preferably used that has a sufficient thickness to absorb an uneven, rugged surface at a portion to be bonded. The double coated adhesive tape 6 is brought into tight contact with the sealing plate 11, which is a surface of the battery, to unfailingly bond the insulation cover 4 with the surface of the battery, and also serves to protect the safety valve 12. When the safety valve 12 opens, the double coated adhesive tape 6 is peeled to release a gas to the outside. The battery pack with the insulation cover 4 being bonded to the battery can prevent the insulation cover 4 from misalignment by the time when the resin molded portion 1 is temporally tacked to the metal mold 30 in a state of the core pack 10. The double coated adhesive tape 6 allows the insulation cover 4 to be bonded with the battery surface easily and readily. Also when the safety valve 12 opens, the tape quickly peels, so that the gas and others can be quickly released out of the opened safety valve 12. The insulation cover 4 can also be bonded to the surface of the battery by the use of adhesive or glue. Like the double coated adhesive tape, the adhesive or glue is also used that has such adhesion strength as may be peeled by the gas pressure released through the opened safety valve.

The illustrated battery pack has one end of the lead plate 5A connected to the protruded electrode 2B of the unit cell 2. The lead plate 5A has its other end connected to the circuit board 3. Further, the illustrated battery pack has the lead plate 5B connected to the sealing plate 11 of the unit cell 2 as well, and the lead plate 5B also has its other end connected to the circuit board 3. The circuit board 3 is connected to the positive and negative electrodes of the unit cell 2, via the lead plate 5 in a pair constituted of the lead plate 5A, connected to the protruded electrode 2B, and the lead plate 5B, connected to the sealing plate 11. The lead plate 5 in a pair is fabricated by cutting a metallic plate into a strip having a predetermined width. The lead plate 5 in a pair connects the circuit board 3 to a predetermined position of the unit cell 2. The illustrated battery pack connects the lead plate 5 in a pair to the two ends of the circuit board 3. The battery pack in this structure can firmly and stably connect the circuit board 3 to the predetermined position of the unit cell 2 by means of the lead plate 5 in a pair.

The lead plate 5A connected to the protruded electrode 2B is disposed in a state of being layered to the insulation cover 4. The insulation cover 4 serves to insulate in prevention of the lead plate 5A connected to the protruded electrode 2B from contacting to the sealing plate 11. The lead plate 5A is provided with an open hole 16 extending through the protrusion 15 which is provided to the insulation cover 4. Since the protrusion 15 is of an elongated shape, the open hole 16 serves as the slit 16A. The lead plate 5A allows the protrusion 15 to fit in the open hole 16 which is the slit 16A, and the lead plate 5A is layered to a predetermined position of the insulation cover 4 without misalignment. Further, the protrusion 15 extended through the opening hole 16 of the lead plate 5A is pressed by the press pin 32 of the metal mold 30 without intermediation of the lead plate 5. In the illustrated battery pack, since the circuit board 3 is layered to the protrusion 15, the insulation cover 4 is pressed by the press pin 32 via the circuit board 3. The lead plate 5 in a pair is spot-welded or laser-welded for connection to the protruded electrode 2B and sealing plate 11 of the unit cell 2. The lead plate 5 is also soldered to be connected to the circuit board 3. The lead plate 5 is provided with a bent piece 5a, which is made by bending a tip of the lead plate 5 at a right angle, the tip being connected to the circuit board 3. The circuit board 3 is provided with a through hole 17 extending through the bent piece 5a. The bent piece 5a is extended through the through hole 17 and soldered for connection to the circuit board 3. Further, an insulation sheet 7 is disposed between the lead plate 5 in a pair, connected to the circuit board 3, and the circuit board 3. The insulation sheet 7 serves to insulate in prevention of the lead plate 5 from contacting the circuit board 3.

The circuit board 3 has the connector 9, serving as an output terminal of the battery pack, fixed to the surface as shown in FIG. 2 and FIG. 5 through FIG. 7. Further, the illustrated circuit board 3 has a protection element 8 implemented for protecting and discharging and charging the unit cell 2. The protection element 8 is a PTC, a breaker, a fuse, or the like. Further, the circuit board 3 can also have a protection circuit implemented for detecting a voltage of the unit cell 2 to control the discharging and charging operations. The protection circuit is so designed that when a discharging battery voltage becomes lower than a minimal voltage, a discharging current is shut down, and when a charging battery voltage becomes higher than a maximal voltage, a charging current is shut down.

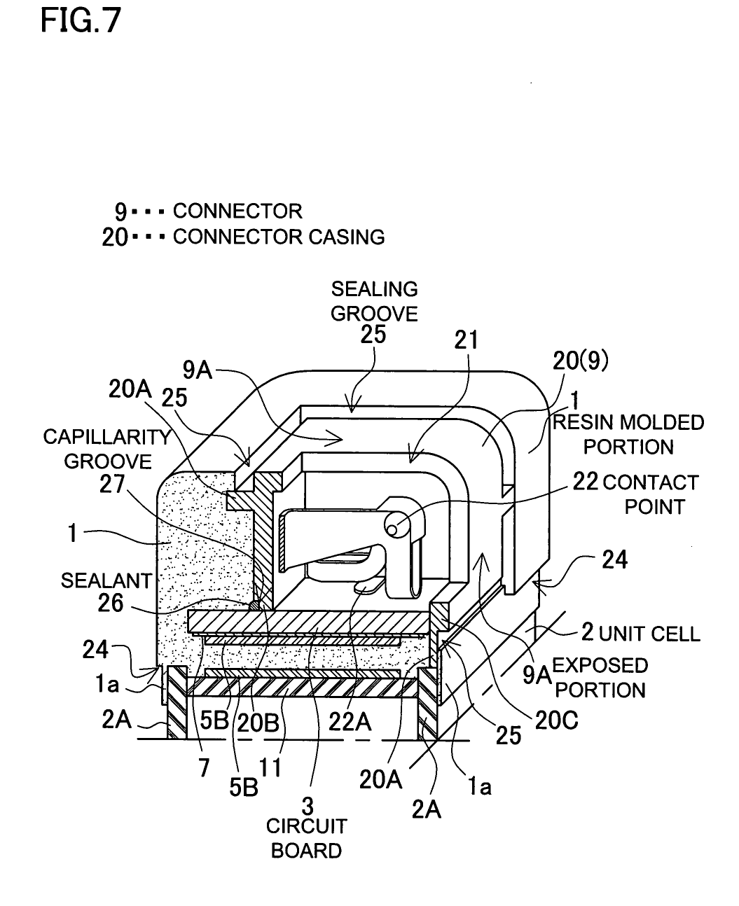

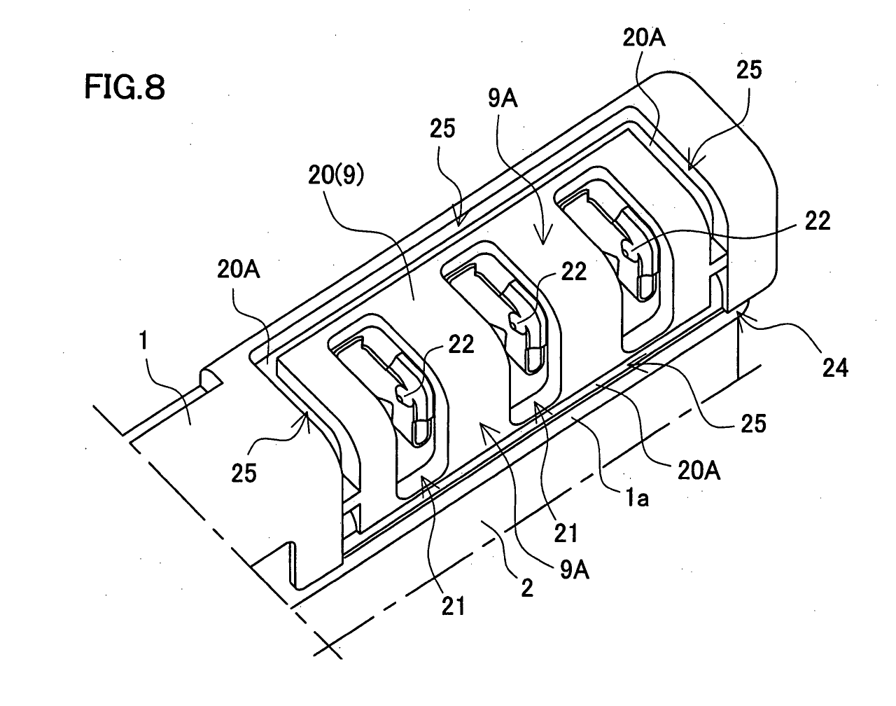

The connector 9 fixed to the circuit board 3 incorporates, in a connector casing 20, a plurality of contact points 22 serving as output terminals. The connector casing 20 is formed of an insulating plastic material in such a shape that a power plug (not shown) of an electric appliance is connectable in a fitting-in structure. The illustrated connector casing 20 in its entirety is shaped in an elongated rectangular solid, and is formed to be hollow inside to accommodate the contact points 22. Further, in the connector casing 20, its bottom face connected to the circuit board 3 is made flat. The illustrated connector casing 20 is provided with three parts of fitting-in recesses 21 to allow the power plugs of the electric appliances to be fitted in for connection. Each of the fitting-in recesses 21 has the contact point 22 at an internal opposite face, so that the contact point 22 is electrically connected to both sides of the power plug inserted into the fitting-in recess 21. In the connector 9, an upper face and a side face in FIG. 7 and FIG. 8 serve as the exposed portion 9A which appear outside the resin molded portion 1. The exposed portion 9A has a respective aperture for the three parts of fitting-in recesses 21, so that the power plug can be inserted from the aperture into each fitting-in recess 21.

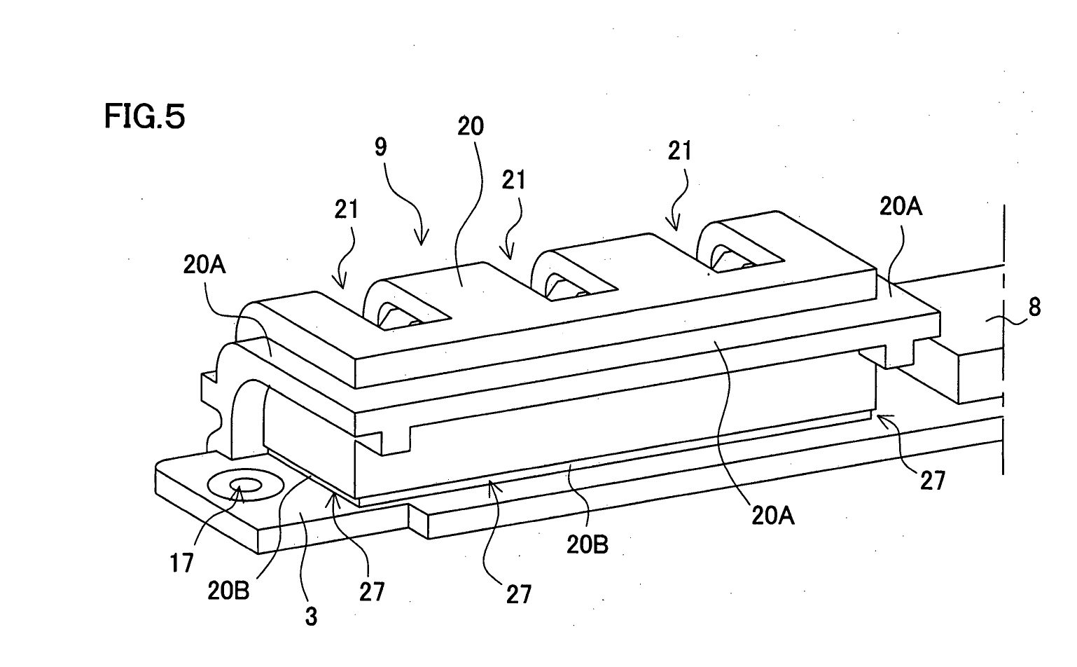

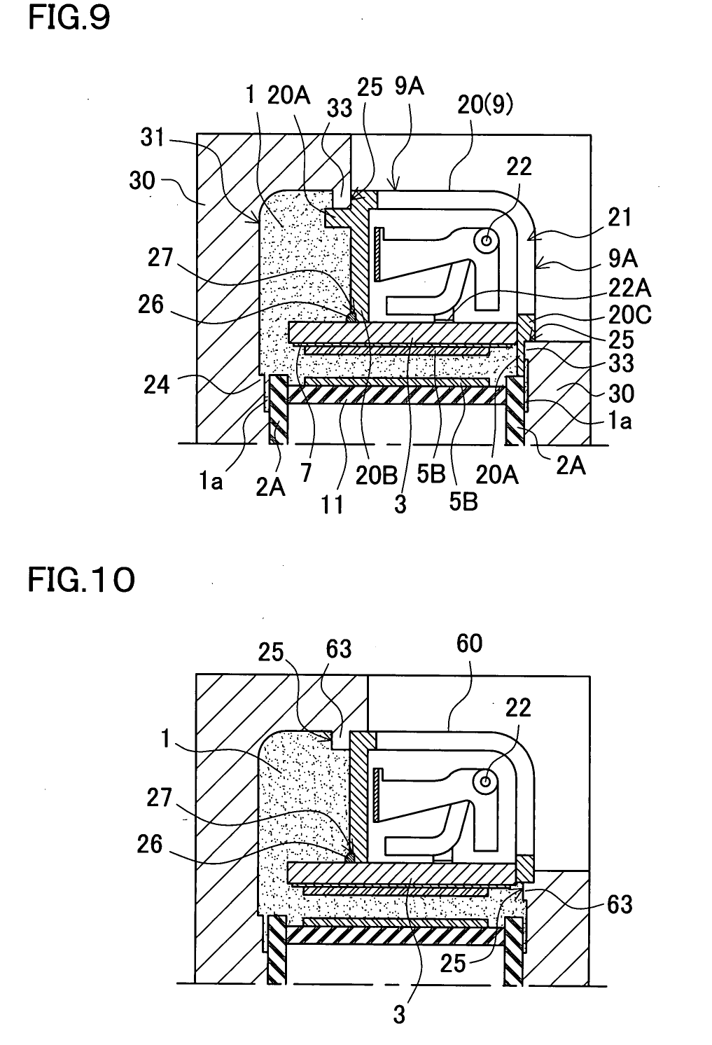

Further, as shown in FIG. 7 and FIG. 8, the battery pack is provided with a sealing groove 25 between the connector casing 20 and the resin molded portion 1, along the peripheral edge of the exposed portion 9A of the connector casing 20. The connector casing shown in FIG. 5 through FIG. 9 is provided with a flange 20A for pressing a top end face of the groove-forming ridge 33 of the metal mold 30 for forming the sealing groove 25. The illustrated battery pack is provided with the sealing groove 25 along the peripheral edge of the exposed portion 9A. As such, the illustrated connector casing 20 is provided with the flange 20A fully along the peripheral edge of the exposed portion 9A. The flange 20A provided along the periphery of the upper surface of the exposed portion 9A is of a horizontal surface with the top surface being in a parallel relationship with the surface of the circuit board 3, and the top end surface of the groove-forming ridge 33 is pressed on to the surface to form a sealing groove 25. The flange 20A provided along the periphery of the side surface of the exposed portion 9A is of a vertical surface with the side surface being in a parallel relationship with the side surface of the unit cell 2, and the top end surface of the groove-forming ridge 33 of the metal mold 30 is pressed on to the surface to form a sealing groove 25. In the connector casing 20 in this structure, since the groove-forming ridge 33 of the metal mold 30 can be pressed on to the flange 20A without producing any gap, the plastic material for forming the resin molded portion 1 can be unfailingly prevented from leaking to the exposed portion 9A under the effect of the forming pressure. Further, the connector casing 20 provided with the flange 20A carries the advantage that the connection strength with respect to the resin molding portion can be increased by burying the tip end of the flange 20A in the resin molded portion 1, as shown in FIG. 7 and FIG. 9. However, as shown in FIG. 10, the sealing groove 25 can also be formed in keeping the side surface of a groove-forming ridge 63 for forming the sealing groove 25 in tight contact with the side surface, so that the connector casing 60 does not necessarily have to be provided with a flange.

The battery pack in FIG. 8 is provided with a sealing groove 25 fully along the peripheral edge of the exposed portion 9A. In the battery pack in this structure can ideally prevent the plastic material of the resin molded portion 1 from covering the exposed portion 9A. However, in the inventive battery pack, instead of providing a sealing groove fully along the peripheral edge of the exposed portion of the connector casing, the sealing groove can also be provided only at the portion where the plastic material is easier to leak, for example in a fluidized state of the molten plastic material which is injected into the cavity, to the exposed portion through the gap existing between the metal mold and the connector casing.

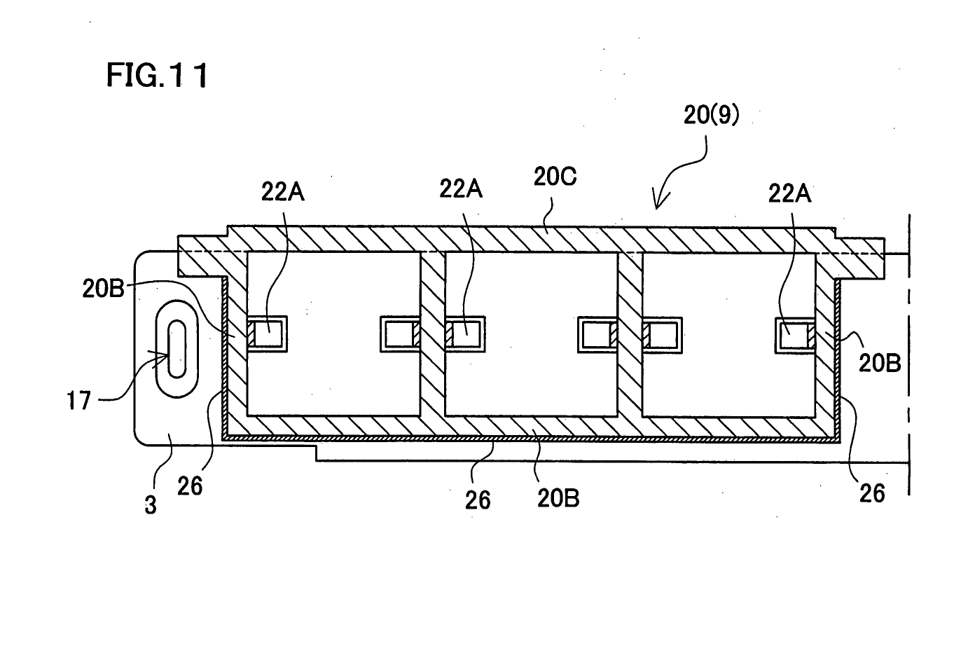

Further, in the case of the connector casing 20 fixed to the circuit board 3, when there exists a gap with respect to the circuit board 3, a molten plastic material penetrates inside the connector casing 20 during the process of forming the resin molded portion 1. It is, therefore, important to fix the connector casing 20 to the circuit board 3 without any gap to exist in between them. In order to seal up the gap between the connector casing 20 and the circuit board 3, the connector casing 20 is so arranged that a sealant 26 such as a silicone is filled in the gap existing in the boundary with respect to the circuit board 3, as shown in FIG. 7 and FIG. 11. The sealant 26 serves to securely seal the gap between the connector casing 20 and the circuit board 3. In order for the sealant 26 to seal the gap between the connector casing 20 and the circuit board 3, the illustrated connector casing 20 is provided with a closure portion 20B along the periphery of the bottom face fixed to the circuit board 3, and is also provided with a capillarity groove 27 which runs along the peripheral edge of the closure portion 20B, at the boundary with respect to the circuit board 3; the sealant 26 penetrates to be filled in the capillarity groove 27 by the capillarity effect.

In the connector casing 20 shown in FIG. 7 and FIG. 11, three sides out of four sides constituting the periphery of the bottom are fixed, in a form of the closure portion 20B, to the surface of the circuit board 3, while the rest one side is fixed, in a form of a protruded wall 20C protruding subjacently to the circuit board 3, to the side of the circuit board 3. As can be seen in FIG. 7, the protruded wall 20C is a plate protruding downwardly of the bottom surface of the closure portion 20B which is fixed to the surface of the circuit board 3. In the connector casing 20 in this structure, as illustrated, while the bottom face of the closure portion 20B is kept in tight contact with the surface of the circuit board 3, the interior surface of the protruded wall 20C is kept in tight contact with the side face of the circuit board 3 and can be positioned and fixed to a predetermined place of the circuit board 3. The illustrated connector casing 20 is provided with the capillarity groove 27 along the boundary with respect to the surface of the circuit board 3, that is to say, substantially fully over the periphery of the closure portion 20B fixed to the surface of the circuit board 3. The connector casing, however, can be provided with the capillarity groove also fully at the boundary with respect to the circuit board, that is, at the boundary between the protruded wall and the circuit board. Further, the connector casing does not necessarily have to be provided with the protruded wall. A connector casing without a protruded wall can be fixed, in a form of the entire periphery of the bottom serving as the closure portion, to the surface of the circuit board. Such connector can be provided with the capillarity groove fully along the boundary with respect to the circuit board.

In the illustrated connector casing 20, the closure portion 20B is in a form of a plate. The connector casing 20 is so designed that the sealant 26 is filled in the capillarity groove 27 provided along the peripheral edge of the closure portion 20B and is fixed to the circuit board 3 without a gap to be produced. In the connector casing, the closure portion does not necessarily have to be in a form of the plate, and the periphery of the connector casing can be shaped to be adjacent to the circuit board and provided with the capillarity groove in the periphery and at the boundary with respect to the circuit board. In the case of a connector casing with a capillarity groove, the gap is small and inconstant between the connector casing and the circuit board, so that it is difficult to fill the sealant to securely seal up the gap. In order to prevent such a difficulty, the capillarity groove 27 is provided along the boundary with respect to the circuit board 3 of the connector casing 20. The capillarity groove 27 is designed to have a gap with respect to the circuit board 3 to be, for example 0.2 mm to 1 mm, so that the sealant 26 to be filled in the gap is allowed to be quickly diffused and penetrated into the entirety by the capillarity effect. When the sealant 26 is filled and diffused in the capillarity groove 27 to seal up the gap between the connector 9 and the circuit board 3, the battery core pack 10 is temporally tacked in the cavity 31 for forming the resin molded portion 1. In this state, the molten plastic material is injected into the cavity 31 and the resin molded portion 1 is formed. The sealant 2 in a non-hardened liquid, is filled in the capillarity groove 27 and is diffused into the capillarity groove 27 by the capillarity effect. As the sealant 26 in a non-hardened liquid, a silicone resin or a urethane resin is used which is hardened into a soft state.

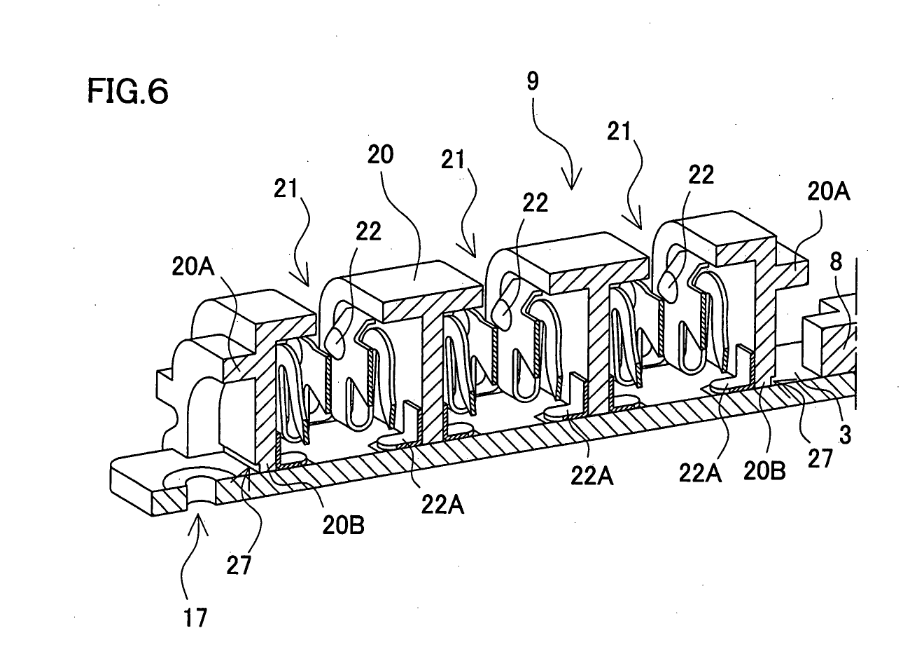

The contact point 22 disposed in the fitting-in recess 21 of the connector casing 20 is of a resilient metallic plate, and is resiliently pressed on to the surface of the power plug to be inserted into the fitting-in recess 21. The contact point 22 is provided, at its lower end, with a fixture piece 22A which is soldered and fixed to the circuit board 3. The fixture piece 22A is connected to the circuit board 3 by a method including soldering, and the connector 9 is connected to the circuit board 3. FIG. 6 shows the state where the contact point 22 of the connector 9 is soldered and fixed to the circuit board 3. The contact point 22 is soldered and fixed to the circuit board 3, and the contact point 22 of the connector 9 is electrically connected to the circuit board 3. The circuit board 3 having the connector 9 fixed is connected to the unit cell 2 via the lead plate 5 in a pair to make up the battery core pack 10, the battery core pack 10 is inserted into the resin molded portion 1, and the connector 9 is inserted into the resin molded portion 1.

The battery core pack 10 can be firmly adhered to the resin molded portion 1 by means of a primer coating (not shown) which is provided over the adhesion area with respect to the resin molded portion 1. The battery core pack, however, does not necessarily have to be provided with the primer coating and can be inserted in and fixed to the resin molded portion. The primer coating applied over the core pack 10 adheres the core pack 10 strongly to the resin molded portion 1 in the process of forming the resin molded portion 1. In particular, the primer coating serves to strongly adhere the resin molded portion 1 to the surface of the metallic unit cell 2. Further, the primer coating is applied on the circuit board 3, the protection element 8 and the surface of the connector 9, to be firmly adhered to the resin molded portion 1. The primer coating is applied on the surface which is adhered to the resin molded portion 1. In regard to the primer coating, a primer liquid being in a liquid form before being hardened is sprayed in a state of mists or alternatively coated with a brush, or the core pack 10 can even be coated with the primer coating by being dipped in a primer liquid. The primer coating is provided to a necessary portion in the state of a core pack 10, or can be applied and provided on the surface of the unit cell 2 before the unit cell 2 is assembled to the core pack 10 and further by being coated on the circuit board 3, the protection element 8 or the connector 9. The primer coating provided over the surface of the connector 9 is coated except for an electrical contact point such as the contact point 22. This is because the primer is to cause a poor contact of the electrical contact point. Since the primer coating is thin and sufficiently effective, the coating thickness is set to be about 1 μm. However, the primer coating may range also between 0.5 and 5 μm in thickness. Since the primer coating serves to protect the surface of the battery in addition to having the effect of strongly adhering the resin molded portion 1, a thicker coating thickness can increase the protection effect accordingly.

In regard to the battery pack, when the resin molded portion 1 is formed of a polyamide resin, the primer coating can be an epoxy resin based primer. The polyamide resin for the resin molded portion 1 is chemically bonded with the primer coating by introducing an epoxy function for the primer coating into an acid-amide bond existing in the resin. Therefore, the resin molded portion 1 is adhered to the primer coating even more strongly. Instead of or in addition to the epoxy resin, the primer liquid for forming the primer coating can be a modified epoxy resin based primer, a phenolic resin based primer, a modified phenolic resin based primer, a polyvinyl butyral based primer, a polyvinyl formal based primer or the like for application. These kinds of primer can also be used in a mixture of a plurality of kinds. These kinds of primer are chemically bonded with the resin molded portion 1 formed of the polyamide resin, as well as being hydrogen-bonded or chemically bonded with a metallic surface, and adheres the resin molded portion 1 strongly to the surface of the battery.

The plastic material for forming the resin molded portion 1 is a polyamide resin. The polyamide resin can also have the epoxy resin added. The epoxy resin added polyamide resin can be stronger in adhesion when compared with a polyamide resin to be used alone. The polyamide resin has a lower softening temperature and also a lower viscosity when melted, so that a formation is possible at a lower temperature and a lower pressure as compared with other thermoplastic resins. The polyamide resin also carries the advantage that the molded portion can be quickly demolded out of the cavity in the metal mold. The resin molded portion 1 which is formed at a lower temperature and at a lower pressure has the advantage of being able to shorten time required for formation, and reducing an adverse influence to the protection element 8 and others under the effect of heat and injection pressure at the time of molding the resin. The inventive battery pack, however, is not limited to the polyamide resin to be used as a resin for forming the resin molded portion 1. Resins other than a polyamide resin, such as a polyurethane resin, can also be used. Further, if the thermal resistance can be improved for the protection element 8 and others to be inserted into the resin molded portion 1, it is possible to use a thermoplastic resin such as a polyethylene resin, an acryl resin, and a polypropylene resin.

The resin molded portion 1 is provided with a thin-walled wrapping portion 1a along the peripheral edge of the sealing plate 11, extending to the surface of the outer casing 2A. The thin-walled wrapping portion 1a is integrally formed in the resin molded portion 1, and is adhered to the outer surface of the unit cell 2 when the resin molded portion 1 is formed. As shown in FIG. 4 and FIG. 9, the molten plastic material injected into the cavity 31 of the metal mold 30 is injected from the periphery of the sealing plate 11 to the part of forming the thin-walled wrapping portion 1a, and the thin-walled wrapping portion 1a is integrally formed in the resin molded portion 1. The thin-walled wrapping portion 1 is preferably provided fully along the periphery of the sealing plate 11. The resin molded portion 1 is connected to the unit cell 2 such that the thin-walled wrapping portion 1a is least likely to be peeled which is provided fully along the circumferential surface of the sealing plate 11. However, the thin-walled wrapping portion can also be provided only to a part of the circumference of the unit cell, for example, the periphery of a surface with a larger width of a thin-type battery.

A width of the thin-walled wrapping portion 1a can be enlarged to increase the strength of bonding with the battery 2. Even if the thin-walled wrapping portion 1a is made narrower substantially, the resin molded portion 1 can be firmly adhered to the unit cell 2. In particular, the battery pack, where a surface covering film (not shown) is stuck over the metallic surface of the unit cell 2, can be arranged not to be peeled when the thin-walled wrapping portion 1a is pressed with the surface covering film on to the surface of the battery. Because of this arrangement, when the thin-walled wrapping portion 1a is narrowed in width ranging between 0.1 and 2 mm, preferably 0.2 and 1 mm, for example in 0.5 mm, the resin molded portion 1 can be firmly connected to the unit cell 2. The thin-walled wrapping portion 1a in a smaller width can be formed to a specified shape by unfailingly injecting the molten plastic material.

The surface covering film is in a state of a heat shrinkable tube which can be contracted when heated. The surface covering film is made into tight contact with the surface of the thin-walled portion 1a of the resin molded portion 1 to firmly connect the resin molded portion 1 to the unit cell 2. Further, the battery pack covered by the surface covering film does not allow a peeled piece to penetrate between the thin-walled wrapping portion 1a and the unit cell 2, and thus the thin-walled wrapping portion 1a can also be prevented from peeling. The surface covering film may also be an adhesive label or adhesive tape. The surface covering film being an adhesive label or adhesive tape is applied to the surface of the resin molded portion and thin-walled wrapping portion or on the surface of the battery, so that the resin molded portion is firmly connected to the battery.

As can be seen in FIG. 1 and FIG. 8, the battery pack can be provided with a step 24 in the outer circumference of the resin molded portion 1, with its lower formed portion being covered with the surface covering film. In the resin molded portion 1, the surfaces of the resin molded portion 1 and the surface covering film can be made generally coplanar, without the surface covering film protruding from the resin molded portion 1.

Further, in the battery pack shown in FIG. 1 and FIG. 2, a plastic body 23 which is formed separately from the resin molded portion 1 is adhered to the end surface opposite to the sealing plate bonded to the resin molded portion 1, namely to the bottom face of the outer casing 2A. The plastic body 23 is formed of a plastic material which is more rigid that the resin molded portion 1. In the plastic body 23, the bottom portion 23A covering the whole area of the bottom face of the outer casing 2A is integrally formed with a second thin-walled wrapping portion 23a extending to the circumferential surface of the unit cell 2 from the bottom face of the outer casing 2A. The bottom portion 23A is formed to be thicker than the second thin-walled wrapping portion 23a.

The above-described battery pack is manufactured in the following procedure.

### (1) Process of Assembling the Circuit Board 3

The circuit board 3 is implemented with the protection element 8 and other electronic components to realize a protection circuit, and the fixture piece 22A of the contact point 22 in the connector 9 is soldered and fixed to the surface of the circuit board 3. Subsequently, the silicone resin based sealant 26 in a non-hardened liquid is filled in the capillarity groove 27 which is provided at the boundary with respect to the circuit board 3 of the connector casing 20. The sealant 26 filled in the capillarity groove 27 is diffused in the capillarity groove 27 by the capillarity effect, so that the gap is sealed between the connector casing 20 and the circuit board 3.

### (2) Process of Assembling the Core Pack 10

In this process, the insulation cover 4 is layered on the sealing plate 11 of the unit cell 2 such that the outlet port 13 of the safety valve 12 is covered which is provided to the sealing plate 11 of the unit cell 2. Further, in the illustrated core pack 10, the lead plate 5A connected by the spot welding to the protruded electrode 2B is layered on the insulation cover 4, and the lead plate 5A is soldered and connected to the circuit board 3. The lead plate 5A is connected to and layered on a predetermined position of the insulation cover 4 by inserting the protrusion 15 of the insulation cover 4 into the open hole 16. Further, another lead plate 5B is spot-welded and connected to the sealing plate 11 of the unit cell 2, and the other end of the lead plate 5B is connected to the circuit board 3, and thus the battery core pack 10 is made up by connecting the circuit board 3 fixed to the connector 9 to the unit cell 2, via the lead plate 5 in a pair. Adhesion of the battery core pack 10 to the resin molded portion 1 can be increased by providing the primer coating to the portion where the resin molded portion 1 is bonded. However, since the primer coating does not necessarily have to be provided, the process of providing the primer coating may optionally be omitted.

### (3) Temporally Bonding Process

The assembled battery core pack 10 is temporally bonded in the cavity 31 of the metal mold 30 which forms the resin molded portion 1. In such a state, the battery core pack 10 is temporally tacked in the cavity 31 of the metal mold 30 without a misalignment. That is to say, in order to hold the temporally bonded battery core pack 10 to the predetermined position, the metal mold 30 interposes the unit cell 2 being surrounded to be held to the predetermined position. Further, the groove-forming ridge 33 protruding to the cavity 31 from the metal mold 30 comes into tight contact with the flange 20A of the connector casing 20. The groove-forming ridge 33 tightly contacts the connector casing 20 along the outer circumference of the exposed portion 9A, and the exposed portion 9A of the connector casing 20 is isolated from the cavity 31. In other words, the plastic material injected into the cavity 31 is in a state of not penetrating on to the surface of the exposed portion 9A. The circuit board 3 is also held to the predetermined position by means of a holder pin (not shown) in the metal mold 30. Also in this process, the protrusion 15 of the insulation cover 4 is pressed toward the surface of the unit cell 2 via the circuit board 3 by means a press pin 32 provided to the metal mold 30. In the battery pack shown in FIG. 3, the outer circumference of the insulation cover 4 is pressed to an end surface of the ridge 14 provided to the peripheral edge of the unit cell 2. The insulation cover 4 to which the protrusion 15 is pressed by the press pin 32 is brought into tight contact with the surface of the unit cell 2. Such a state is continued in a subsequent step of resin injection process as well. Thus, the insulation cover 4 continues to be in tight contact with the surface of the unit cell 2 in the ensuing process of resin injection as well.

### (4) Process of Resin Injection

When the cavity 31 of the metal mold 30, where the battery core pack 10 is temporally tacked, is closed, the molten plastic material is injected into the cavity 31 with the metal mold 30 being in a clamped state. The plastic material injected in the cavity 31 forms the resin molded portion 1. The plastic material to be injected into the cavity 31 is injected in a state where the plastic material is prevented from penetrating to the exposed portion 9A of the connector casing 20 by the aid of the groove-forming ridge 33 being in tight contact with the surface of the connector casing 20. In regard to the resin molded portion 1 which is formed in the cavity 31, while the exposed portion 9A of the connector 9 appears externally, a part of the connector 9, the circuit board 3, the lead plate 5 and the insulation cover 4 are inserted. Further, the resin molded portion 1 is formed into a shape of adhering the thin-walled wrapping portion to the outer circumference of the unit cell 2. The resin molded portion may also allow a part of the plastic body fixed to the bottom face of the unit cell to be inserted.

### (5) Demolding Process

When the molten plastic material injected in the cavity 31 is cooled and hardened, the metal mold 30 is unclamped and the battery pack is demolded out of the metal mold 30. The demolded battery pack is firmly connected to the unit cell 2, with a part of the core pack 10 being inserted into the resin molded portion 1 being formed in the cavity 31 of the metal mold 30 and with the exposed portion 9A of the connector 9 appearing externally.

Lastly, although not shown, the battery pack is put into the tubular surface covering film being a heat shrinkable tube, which is then subjected to a heat to be in tight contact with the surface of the battery pack. The surface covering film is put into tight contact with the surface of the thin-walled wrapping portion 1a of the resin molded portion 1 and also with the surface of the second thin-walled wrapping portion 23 of the plastic body 23, and the resin molded portion 1 and the plastic body 23 are firmly connected to the unit cell 2.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims.

The present application is based on Application No. 2006-327462 filed in Japan on Dec. 4, 2006, the content of which is incorporated herein by reference.

What is claimed is:

1. A battery pack comprising:
a resin molded portion formed of a plastic material; and
a battery core pack having a connector, the battery core pack being inserted into the resin molded portion,
wherein the battery core pack includes a rechargeable unit cell, a circuit board electrically connected to the unit cell, and the connector fixed to the circuit board,
wherein the connector incorporates a contact point in a connector casing formed of an insulation material, as well as the connector casing is inserted into the resin molded portion so as to partially appear to a surface of the resin molded portion, and
wherein the connector is provided with a sealing groove at a boundary of the connector casing and the resin molded portion, the sealing groove running along a peripheral edge of an exposed portion which appears outside the resin molded portion.

2. The battery pack as recited in claim 1, wherein the connector casing is provided with a flange for pressing a tip surface of a groove-forming ridge of a metal mold which forms the sealing groove.

3. The battery pack as recited in claim 2, wherein the flange, provided along the periphery of a top surface of the exposed portion of the connector casing, the top surface being a horizontal surface in a parallel relationship with a surface of the circuit board, forms the sealing groove defined by the tip surface of the groove-forming ridge of the metal mold being pressed upon the horizontal surface.

4. The battery pack as recited in claim 2, wherein the flange, provided along the periphery of a side surface of the exposed portion of the connector casing, with the side surface being a vertical surface in a parallel relationship with a side surface of the unit cell, forms the sealing groove defined by the tip surface of the groove-forming ridge of the metal mold being pressed upon the vertical surface.

5. The battery pack as recited in claim 2, wherein the connector casing has a tip of the flange buried in the resin molded portion.

6. The battery pack as recited in claim 1, wherein a side surface of a groove-forming ridge of the metal mold for forming the sealing groove is in close contact with a side surface of the connector casing to form the sealing groove.

7. The battery pack as recited in claim 1, wherein the sealing groove is formed fully along the peripheral edge of the exposed portion of the connector casing.

8. A battery pack comprising:
a resin molded portion formed of a plastic material; and
a battery core pack having a connector, the battery core pack being inserted into the resin molded portion, the connector being integrally structured with the resin molded portion,
wherein the battery core pack includes a rechargeable unit cell, a circuit board electrically connected to the unit cell, and the connector fixed to the circuit board, and
wherein the connector is so structured as to incorporate a contact point in a connector casing formed of an insulation material; the connector casing is provided with a capillarity groove to allow a sealant to be filled in a boundary with respect to the circuit board by a capillarity effect; the capillarity groove is filled with the sealant to seal a gap existing between the connector casing and the circuit board; the battery core pack is inserted into the resin molded portion; and the connector is inserted into the resin molded portion.

9. The battery pack as recited in claim 8, wherein the connector casing is provided with the capillarity groove running along a peripheral edge of an enclosed portion fixed to a surface of the circuit board, along a boundary with respect to a/the surface of the circuit board.

10. The battery pack as recited in claim 8, wherein the connector casing is provided with the capillarity groove at the boundary portion between a protruded wall and the circuit board, over the entire boundary with respect to the circuit board.

11. The battery pack as recited in claim 8, wherein the connector casing has the enclosed portion shaped of a plate, and the sealant is filled in the capillarity groove provided along the peripheral edge of the enclosed portion.

12. The battery pack as recited in claim 8, wherein the capillarity groove has a distance of 0.2 mm to 1 mm with respect to the circuit board.

13. The battery pack as recited in claim 8, wherein the sealant is either a silicone resin or a urethane resin, both of which is solidified in a soft state.

14. A battery pack comprising:
a resin molded portion formed of a plastic material; and
a battery core pack having a connector, the battery core pack being inserted into the resin molded portion,
wherein the battery core pack includes a rechargeable unit cell, a circuit board electrically connected to the unit cell, and a connector fixed to the circuit board,
wherein the connector is provided with a capillarity groove to allow a sealant to be filled in a boundary with respect to the circuit board by a capillarity effect; the capillarity groove is filled with the sealant to seal a gap existing between the connector and the circuit board; and the battery core pack is inserted and formed into the resin molded portion;
wherein the connector incorporates a contact point at the connector casing formed of an insulation material, as well as the connector casing is inserted into the resin molded portion so as to partially appear to a surface of the resin molded portion; and
wherein the connector is provided with a sealing groove at the boundary between the connector casing and the resin molded portion, the sealing groove running along a peripheral edge of an exposed portion appearing outside the resin molded portion.
